(19) United States
(12) Patent Application Publication
(10) Pub. No.: US 2011/0100507 A1
(43) Pub. Date: May 5, 2011

(54) APPARATUS AND METHOD FOR CONTROLLING THE DISPENSING OF A LIQUID INTO A CONTAINER, PARTICULARLY USEFUL IN VEHICLE FUEL DISPENSING SYSTEMS

(75) Inventors: Shimon Weitzhandler, RaAnana (IL); Avi Yalon, Ramat-Gan (IL); Yoav Vilnai, Tel-Aviv (IL)

(73) Assignee: Petratec International Ltd., Kfar-Saba (IL)

(21) Appl. No.: 13/002,337

(22) PCT Filed: Jul. 1, 2009
(86) PCT No.: PCT/IL2009/000657

§ 371 Date: Jan. 3, 2011

Related U.S. Application Data
(60) Provisional application No. 61/129,534, filed on Jul. 2, 2008.

(51) Int. Cl. B65B 31/00; G06K 7/01

(52) U.S. Cl. 141/94; 340/10.1

(57) ABSTRACT

Apparatus and method for dispensing a liquid fuel into the inlet of a vehicle fuel tank by means of a fuel dispensing pump including metering means for measuring the quantity of liquid fuel dispensed, and a nozzle carrying a wireless transponder device for interrogating an RFID carried by the respective vehicle to enable identification of the respective vehicle; characterized in that the fuel inlet of the respective vehicle fuel tank carries said RFID to be interrogated by the transponder of the nozzle, when inserted into said inlet, to receive the identification of the respective vehicle, said RFID on the vehicle transmits to the transponder on the nozzle the identification of the respective vehicle; and said apparatus further includes a data processor for processing the identification of the respective vehicle receiving the measured quantity of liquid fuel to provide information concerning the operation of the respective vehicle.

### FIELD AND BACKGROUND OF THE INVENTION

The present invention relates to an apparatus and method for controlling the dispensing of a liquid into a container. The invention is particularly useful in vehicle fuel dispensing systems, and is therefore described below with respect to such an application, but it will be appreciated that the invention could be used in many other applications as well.

Automatic vehicle fuel refueling systems are gaining widespread use because of their convenience and cost savings, both in the refueling of the vehicles, and also in the monitoring of fuel expenses and other information regarding the respective vehicles. A key requirement of such systems is to assure that the vehicle receiving the fuel is properly identified, and is also properly authorized to receive the fuel. The system may also provide additional information both to the vehicle owners and to a central station as to the mileage traveled by the respective vehicle, the fuel costs of the respective vehicle, the need for servicing or repair because of a significant droppage in mileage, etc.

Many such systems have been proposed and are now in use. Examples of such known systems are described in U.S. Pat. Nos. 5,671,786; 6,024,142; and 6,900,719. As a rule, an RFID radio frequency identification device is placed inside the vehicle at some location near the inlet to the fuel tank of the vehicle to reduce the communication distance required between the RFID on the vehicle, and a transponder on the nozzle.

Such systems, while well known in vehicle refueling systems, are not as widely know, if at all, in other systems for controlling the dispensing of other liquids into containers, which may require identification of the respective container and possibly other data concerning the respective container.

### OBJECTS AND BRIEF SUMMARY OF THE PRESENT INVENTION

An object of the present invention is to provide apparatus for controlling the dispensing of a liquid into a container having advantages in the above respects. Another object of the invention is to provide apparatus for controlling the dispensing of fuel into a vehicle fuel tank having advantages in the above respects. A further object of the invention is to provide a method of controlling the dispensing of a liquid into a container particularly useful for retrofitting containers in general, and vehicles in particular, to provide the advantages of RFID controlled systems.

According to a broad aspect of the present invention, there is provided apparatus for controlling the dispensing of a liquid into a container, comprising: a container to receive the liquid to be dispensed; an RFID carried by the respective container for identifying the respective container; and a dispensing device including a nozzle carrying a wireless transponder device for interrogating the RFID of each container presented to the nozzle for receiving liquid therefrom to enable identification of the respective container; characterized that the RFID is carried by the liquid inlet to the respective container to be interrogated by the transponder of the nozzle to receive the identification of the respective container.

As indicated above, the apparatus of the present invention is particularly useful in automatic vehicle refueling systems, wherein the container to receive the liquid is the fuel tank, and the dispensing device for dispensing the liquid is a fuel pump. When the apparatus is used in vehicle refueling systems, the distance between the wireless transponder device of the nozzle and the RFID of the vehicle can be minimal since the nozzle is inserted into the inlet of the vehicle fuel tank.

According to further features in the preferred embodiment of the invention described below, said RFID is included within an inlet adaptor constructed to be applied to the fuel inlet of the respective vehicle, thereby enabling existing vehicles to be conveniently retrofitted for identification purposes.

According to still further features in the described preferred embodiment, the inlet adaptor also carries a locking element such that when the inlet adaptor is applied to the fuel inlet of the respective vehicle, it and the RFID carried thereby, are non-removable therefrom without breaking the locking element.

A particularly preferred embodiment of the invention is described below, wherein the vehicle inlet includes a base ring for receiving the nozzle of the dispenser device, and a cap having connector elements attachable to, and detachable from, complementary connector elements in the base ring which the cap is rotated in opposite directions, respectively, with respect to the base ring; and wherein the adaptor also includes on its lower face connector elements corresponding to those of the cap, and on its upper face connector elements corresponding to those of the base ring.

In the described preferred embodiment, connector elements on the cap and on the lower face of the adaptor ring are ribs, and the connector elements on the body ring and on the upper face of the adaptor ring are slots.

Also in the described preferred embodiment, the RFID includes an antenna and an integrated circuit chip both adapted to be sandwiched between the lower surface of the adaptor ring and the upper surface of the base ring when the adaptor ring is attached thereto. In addition, the lower surface of the adaptor ring further carries a locking pin spring-biased into a hole in the upper surface of the base ring, when the adaptor ring is locked thereto by rotating the adaptor ring with respect to the base ring, such that the locking pin prevents rotating the adaptor ring in the opposite direction, without breaking the locking pin, to thereby prevent removal of the adaptor ring and the RFID carried thereby from the base ring.

According to a further aspect of the present invention, there is provided a method for controlling the dispensing of a liquid into a container, comprising: providing the inlet to the respective container with an RFID for identifying the respective container; and providing the dispensing device with a nozzle carrying a wireless transponder device for interrogating the RFID of each container presented to the nozzle for receiving liquid therefrom, to enable identification of the respective container.

It will be appreciated that the advantages provided above are particularly important when the invention is applied to vehicle refueling systems, since the respective vehicle is not only identified by the RFID carried by the vehicle, but also various other information carried by vehicle can be received by the transponder, such as mileage, total fuel consumption, possibility of the need for service or repair, vehicle speed, etc.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a block diagram illustrating a vehicle refueling system constructed in accordance with the present invention;

FIG. 2 illustrates an assembly of a conventional fuel tank inlet retrofitted with an inlet adaptor constructed in accordance with the present invention to include an RFID, together with a conventional cap of the fuel tank inlet;

FIG. 3 is an exploded view illustrating the main components of the retrofitted fuel tank inlet of FIG. 2;

FIG. 4 is a top plan view of the retrofitted assembly of FIG. 2 with the cap removed;

FIG. 5 is a sectional view along line A-A of FIG. 4;

FIG. 6 is a section view along line B-B of FIG. 4;

and FIG. 7 is a perspective view, from the top, of the base ring in the assembly of FIG. 2.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF A PREFERRED EMBODIMENT

### The Overall System

As indicated earlier, the apparatus and method of the present invention may be used for controlling the dispensing of a liquid into a container, but is particularly useful for vehicle refueling systems; therefore, the preferred embodiment of the invention described below illustrates such an application.

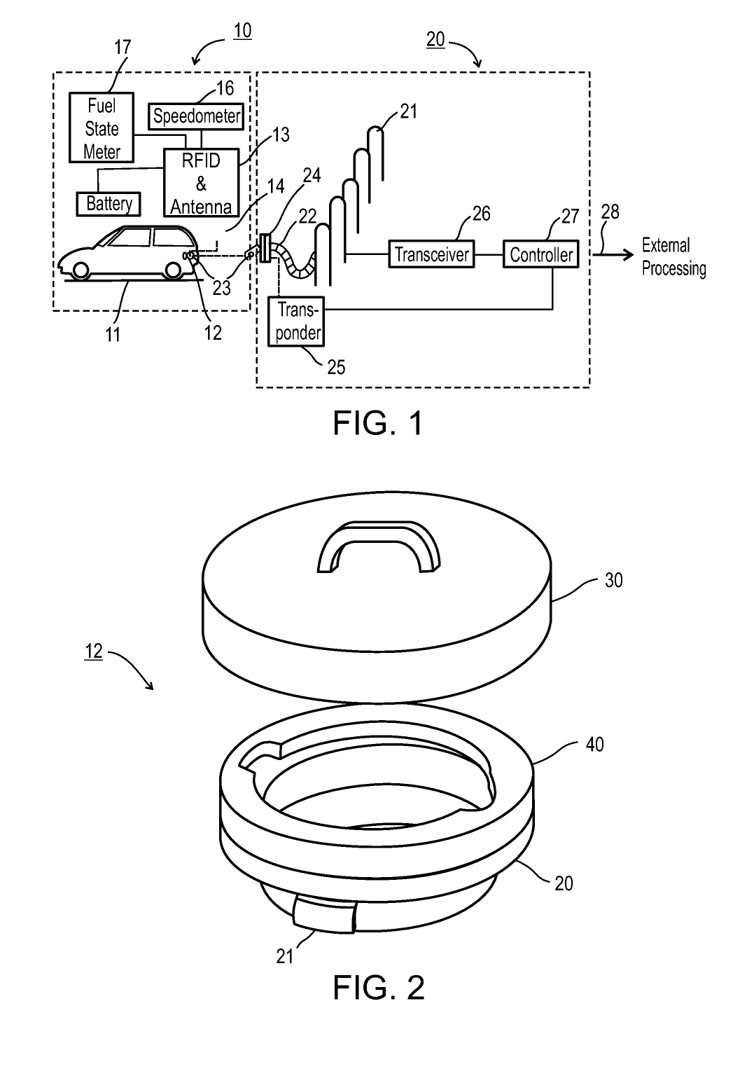

In FIG. 1, the vehicle, and its components involved in the present invention, are schematically indicated as being within box 10; whereas the refueling, station and its components involved in the present invention, are schematically illustrated by being within box 20.

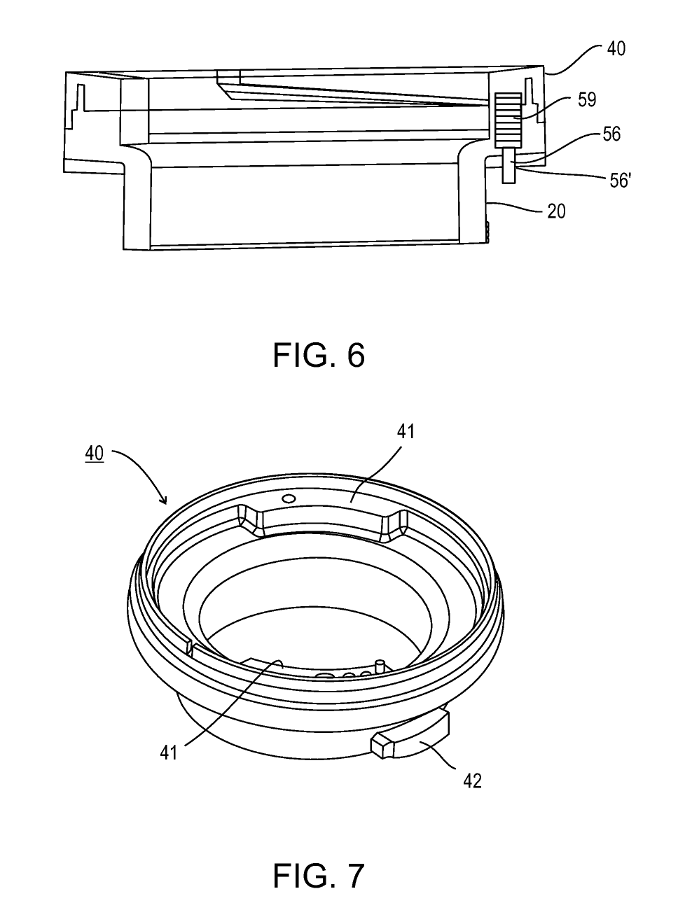

Thus, as seen in box 10 of FIG. 1, the vehicle itself is indicated at 11 and the inlet to its gas tank is in the form of an assembly indicated at 12 and more particularly illustrated in FIGS. 2-7. The vehicle carries an RFID (radio frequency identification device), as schematically indicated by box 13. In this case, the RFID is an integrated circuit chip including the electronic circuitry needed for such a device, and an antenna for wireless transmission and reception of information. Both are included in the inlet 12 to the fuel tank, as schematically indicated by line 14 and as will be described more particularly below. The RFID 13 is powered by a battery 15.

As well known in RFIDs of this type, it contains an identification of the respective vehicle, as well as means for measuring, storing and/or transmitting various data concerning the operation of the vehicle, as schematically illustrated by speedometer 16 and the fuel state meter 17 in FIG. 1. As will be described below with respect to FIGS. 2-7, the RFID 13 is carried within an adaptor ring to be attached to the fuel tank inlet assembly 12.

The refueling station, as indicated by block 20, includes a plurality of pumps shown at 21, each having a dispensing hose 22 terminating in a nozzle 23 for insertion into the fuel tank inlet 12 of the vehicle to be refueled. Each nozzle 23 includes a coil 24 which, when the nozzle is inserted into the fuel tank inlet, becomes inductively coupled to the RFID 13 carried by the fuel tank inlet. When a nozzle 23 is inserted into a fuel tank inlet 12, an inductive coupling is effected between coil 23 and the antenna within the RFID 13.

Thus, when nozzle 23 is inserted into the vehicle fuel tank inlet 12, a transponder 25 in the refueling station interrogates the RFID 13 of the vehicle to identify itself, whereupon the RFID 13 transmits its identification, together with possibly other data, to the station transceiver 26. The transponder 25 and transceiver 26 are controlled by a controller 27 which also processes the information received from the vehicle RFID 13 such data may be processed within the fueling station itself, or may be transmitted externally for external processing, as shown by arrow 28.

Since such refueling systems are generally well know, the further description below will be focused on the manner in which the vehicle fuel tank inlet assembly 12 is constructed or modified to house the RFID and its antenna, as shown by block 13 in FIG. 1

### The Construction of the Vehicle Fuel Tank Inlet Assembly 12

The vehicle fuel inlet 12 of FIG. 1 is more particularly illustrated in FIGS. 2-7. Thus, it includes a conventional base ring 20 fixed in the inlet of the vehicle fuel tank and is normally closed by a removable cap 30. Such caps include locking elements on the lower face (not shown) interlocking with complementary locking elements on the upper face of the base ring 20, as will be described more particularly below, such that rotating the cap in one direction detaches the cap from the base ring 20 of the fuel tank inlet, whereas rotating the cap in the opposite direction reattaches the cap to the base ring to close the fuel tank inlet.

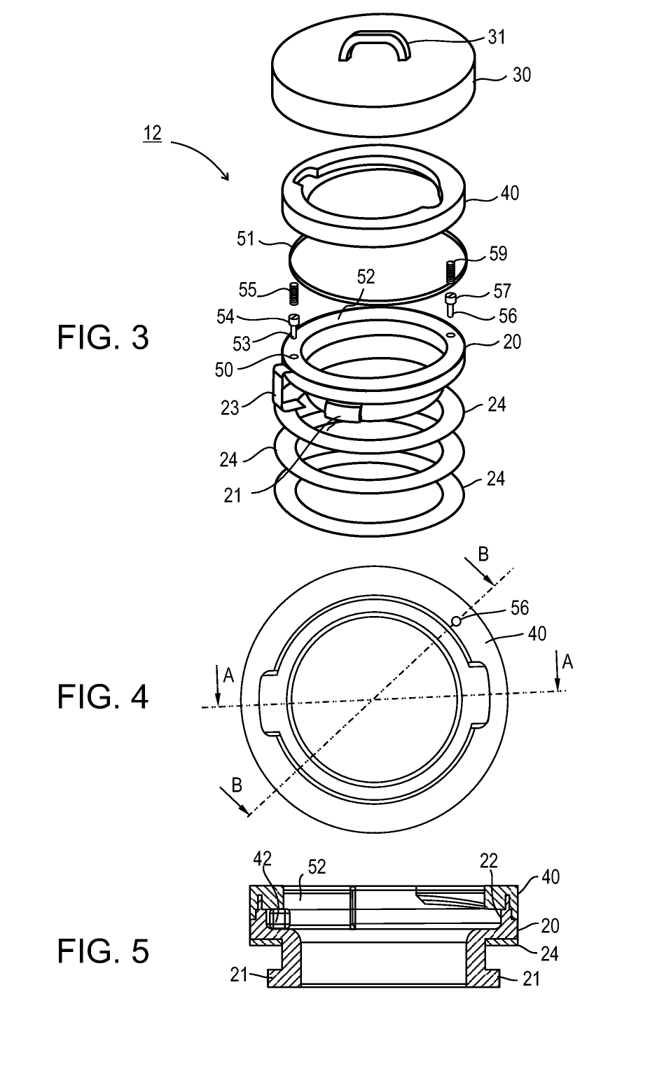

According to the present invention, the RFID 13 of the vehicle is carried within the base ring 20 of the fuel inlet. In the preferred embodiment of the invention described below, this is done by having the RFID included within an inlet adaptor, generally designated 40 in FIGS. 2 and 3, when the inlet adaptor is applied to the base ring 20 of the fuel inlet. As will also be described below, the adaptor ring 40 includes, on its lower face, connector elements corresponding to those of the cap 30, and on its upper face connector elements corresponding to those of the fluid inlet base ring 20 such that the cap 30 is attached to, and detachable from, the adaptor ring 40 in the same manner as it would be attached to and detached from the base ring 20 in the conventional fuel inlet. In addition, and as will be further described below, the adaptor ring 30 also carries a locking element which becomes effective when the adaptor ring 40, and the RFID, are attached to the base ring 20, such that neither can be detached therefrom without breaking the locking element.

The individual elements of the fuel tank inlet assembly 12 are more particularly illustrated in the exploded view of FIG. 3.

Thus, as shown in FIG. 3, assembly 12 includes the above-mentioned base ring 20 normally attached to the inlet of the fuel tank, and the normally-provided cap 30 removably attachable to and detachable from the base ring in order to allow the entry of the pump nozzle holes for pumping the fuel into the fuel tank. The lower portion of base ring 20 is formed with a pair diametrically-opposed outwardly extending lugs or ribs 21 for securing the base ring within the fuel inlet, and its upper portion is formed with a pair of diametrically-opposed slots 22 cooperable with corresponding ribs or lugs (not seen) in the under face of cap 30, for firmly securing the cap to the base ring. In addition, the base ring includes a U-shaped safety device 23, and a plurality of sealing discs 24 interposed between the bottom of base ring 20 and a ledge (not shown) at the entry end of the fuel line to the fuel tank.

It will thus be seen that, in the conventional fuel inlet assembly, the cap 30 may be applied directly to the base ring 20; may be rotated in one direction to detach it from the base ring, and thereby permit the entry of the fuel pump nozzle into the fuel inlet; and may be reattached to the base ring by rotating the cap in the opposite direction, to close the fuel tank inlet. The rotation of the cap in one or the other directions is facilitated by a finger piece 31 integrally formed on the upper face of the cap.

As indicated above, the fuel tank inlet assembly 12 further includes an adaptor in the form of a ring 40, and an RFID 13, to be fixed within the fuel inlet tube in order to adapt the vehicle for receiving fuel in accordance with the present invention. For this purpose, adaptor ring 40 is formed on its upper end with opposed lugs 41 (FIG. 7) corresponding to lugs or ribs 24 in the lower end of base ring 20, and its lower portion with lugs or ribs 42 defining slots between them corresponding to slots 22 in the base ring 20. Thus, when the adaptor ring 40 is applied to the base ring, it cooperates with the cap 30 in the same manner as cap 30 cooperates with the base ring 20 in the conventional fuel tank inlet assembly.

In accordance with the present invention, the fuel tank inlet assembly 12 illustrated in FIG. 3 further includes an RFID (radio frequency identification device) in the form of a pin 50, and a circular antenna 51 for providing the inductive coupling with respect to the transponder 25 carried by the fuel pump nozzle at the refueling station, as indicated at 23 in FIG. 1. The electronic circuitry of the RFID 50 is included in a microchip configured as a pin received within a curved slot 52 formed in the upper face of base ring 20. The upper end of the RFID pin 50 includes an enlarged head 53 extending outwardly of slot 52 and formed with a cylindrical seat 54 for receiving one end of a spring 55; the opposite end of the spring is engageable by the adaptor ring 40 when applied to the base ring 20 to securely seat the pin within slot 52.

The fuel tank inlet assembly 12 illustrated in FIG. 3 further includes the previously-mentioned locking pin 56. It is receivable within the opposite end of slot 22 and includes an enlarged head 57 formed with a cylindrical seat 58 for seating one end of another spring 59. The opposite (upper) end of spring 59 is engageable by the under face of the adaptor ring 40 to firmly bias locking pin 56 into an enlarged hole 56′ (FIG. 6) formed in the end of slot 22 of the base ring 20. When the adaptor ring 40 is first applied to the base ring 20, locking pin is at the end of slot 22 opposite to hole 56′, when the adaptor ring is then rotated it seats pin 56 into hole 56′ formed in the base ring.

### Manner of Use

The parts illustrated in FIG. 3 may be assembled as shown, and adapter ring 40 may be rotated until the locking pin 56 snaps into opening 56′ of the base ring. This firmly attaches the adaptor ring to the base ring and prevents removal of the adaptor ring without breaking pin 56. Thus, once the adaptor ring 40 is attached, the RFID 50 and its antenna 51 are sandwiched between the adaptor ring and the base ring 20 and cannot be removed in order to remove or replace the RFID or its antenna 50 without breaking the locking pin 56.

It will thus be seen that existing fuel tank inlets can be conveniently converted or upgraded for use in fuel dispensing systems in accordance with the present invention, by merely attaching the adaptor ring 40, and the RFID 50 and its antenna 51, sandwiched between it and the conventional base ring 20. The RFID included within the fuel tank inlet will thus be inductively coupled to transponder 25 of the refueling station 20 to provide the fueling station with the proper identification needed for dispensing the fuel, and any other further data which may be desired for processing with respect to the respective vehicle.

As indicated above, while the invention has been described with respect to dispensing systems for dispensing fuel into vehicle fuel tank inlets, it can also be used dispensing other liquids into other types of containers by merely applying a corresponding adapting ring and RFID to the inlet of the respective container.

Many other variations, modifications and applications of the invention will be apparent.

What is claimed is:

1-8. (canceled)

9. Apparatus for dispensing a liquid fuel into the inlet of a vehicle fuel tank by means of a fuel dispensing pump including metering means for measuring the quantity of liquid fuel dispensed, and a nozzle carrying a wireless transponder device for interrogating an RFID carried by the respective vehicle to enable identification of the respective vehicle;
characterized in that:
the fuel inlet of the respective vehicle fuel tank carries said RFID to be interrogated by the transponder of the nozzle, when inserted into said inlet, to receive the identification of the respective vehicle;
said RFID on the vehicle transmits to the transponder on the nozzle the identification of the respective vehicle;
and said apparatus further includes a data processor for processing the identification of the respective vehicle receiving the measured quantity of liquid fuel to provide information concerning the operation of the respective vehicle.

10. The apparatus according to claim 9, wherein said RFID is included within an inlet adaptor constructed to be applied to said fuel inlet of the respective vehicle fuel tank, thereby enabling existing vehicles to be retrofitted for identification purposes.

11. The apparatus according to claim 10, wherein said inlet adaptor also carries a locking element such that when the inlet adaptor is applied to the fuel inlet of the respective vehicle fuel tank, it and the RFID carried thereby, are non-removable therefrom without breaking the locking element.

12. The apparatus according to claim 10,
wherein said fuel inlet includes a base ring for receiving the nozzle of the fuel dispensing pump, and a cap having connector elements attachable to, and detachable from, complementary connector elements in the base ring when the cap is rotated in opposite directions, respectively, with respect to the base ring;
and wherein said inlet adaptor also includes on its lower face connector elements corresponding to those of the cap, and on its upper face connector elements corresponding to those of the base ring.

13. The apparatus according to claim 12, wherein the connector elements on the cap and on the lower face of the adaptor ring are ribs, and the connector elements on the body ring and on the upper face of the adaptor ring are slots.

14. The apparatus according to claim 12, wherein said RFID includes an antenna and an integrated circuit chip both sandwiched between the lower surface of the adaptor ring and the upper surface of the base ring when the adaptor ring is attached thereto.

15. The apparatus according to claim 14, wherein the lower surface of the adaptor ring further carries a locking pin spring-biased into a hole in the upper surface of the base ring, when the adaptor ring is locked thereto by rotating the adaptor ring with respect to the base ring, such that the locking pin prevents rotating the adaptor ring in the opposite direction, without breaking the locking pin, to thereby prevent removal of the adaptor ring and the RFID carried thereby from the base ring.

16. The method for dispensing a liquid fuel into the inlet of a vehicle fuel tank by means of a fuel dispensing pump having metering means for measuring the quantity of liquid fuel dispensed, said method comprising:
providing said inlet of the respective vehicle with an RFID for identifying the respective vehicle;
providing said nozzle of the fuel dispensing pump with a wireless transponder device for interrogating the RFID of each vehicle presented to the nozzle for receiving liquid fuel therefrom, to enable identification of each vehicle receiving liquid fuel;
and processing of said metered quantity of liquid fuel with the identification of the vehicle receiving same, to provide information concerning the operation of the respective vehicle.

17. The method according to claim 16, wherein said RFID is included within an inlet adaptor constructed to be applied to said liquid inlet of the respective vehicle, thereby enabling existing vehicles to be retrofitted for identification purposes.

18. The method according to claim 17, wherein said inlet adaptor also carries a locking element such that when the inlet adaptor is applied to the liquid inlet of the respective container, it and the RFID carried thereby, are non-removable therefrom without breaking the locking element.

19. The method according to claim 16, wherein said container to receive the liquid to be dispensed is a vehicle fuel tank, and the dispensing device for dispensing the liquid is a fuel pump.

20. (canceled)
